(19) United States
(12) Patent Application Publication
(10) Pub. No.: US 2025/0348844 A1
(43) Pub. Date: Nov. 13, 2025

(54) Method for producing reports on emails between employees and customers or suppliers of organizations

(71) Applicant: Yotam Zakai, Ramat Gan (IL)

(72) Inventor: Yotam Zakai, Ramat Gan (IL)

(21) Appl. No.: 18/659,060

(22) Filed: May 9, 2024

(51) Int. Cl. G06Q 10/107

(52) U.S. Cl. CPC G06Q 10/107

(57) ABSTRACT

A computer implemented method for producing specific reports on electronic messages between employees and customers or suppliers of an organization. The method includes the steps of connecting to the email system of the organization, entering details of a specific employee and a specific customer or supplier and a specific period of time, collecting data from the email system about electronic messages between the specific employee and the customer or supplier in that period, counting the amount of sent and received messages between the employee and the customer or supplier during that period, and presenting a specific report with the amount of the sent and received messages. The method further comprises identifying subjects or summarized common topics of the sent and received messages, and identifying involved employees identified as CC recipients in those messages, and including them in the report.

### TECHNICAL FIELD

The present invention refers to a method for producing specific management reports on electronic messages communication between employees of an organization and the customers or suppliers of the organization.

### BACKGROUND ART

There is a constant need to improve monitoring, management control, Decision-making, business processes, Insights, and resources allocation of organizations on the performance of employees vis-a-vis suppliers and customers. The present invention discloses a method for utilizing the information contained in the organization's outgoing and incoming e-mail database producing a specific management report for each employee, in connection with each customer or supplier of the organization, for each selected period of time.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts schematically the processing device (10), the email system (11), the computer (12) and the specific report (13).

### THE INVENTION

The main objective of the present invention is to provide a computer implemented method running on a processing device (10) for producing specific management reports on electronic messages communication between employees of an organization and customers or suppliers of the organization. The term processing device in this disclosure and in the claims means any processor, computing unit, or any hardware inside a computer that interprets and manipulates incoming data.

The method comprises one or more of the following steps:

(a) Connects, by the processing device, to an email system (11) of the organization in which the electronic messages communication between the employees of the organization and the customers and/or the suppliers is stored. The email system of the organization means any system or software in which the organization's e-mail correspondence is conducted or a database that includes the organization's outgoing and incoming e-mails.

(b) Enters, through a computer (12), details of a specific employee of the organization. The details may be the name of the employee, his nickname, his ID number, his email address, or any kind of detail that can identify this specific employee. The term “computer” includes any kind of computer or a system that includes a processing device, and it can be a central computer of the organization, a desktop computer, a laptop, a tablet, a smartphone, and the like.

(c) Enters, through the computer, details of a specific customer or supplier of the organization. The goal is to enable authorized managers in the organization to check and know at any given moment data about the email communication between a specific employee in the organization and a specific customer or supplier of the organization.

(d) Enters, through the computer, a specific period of time; to specify the certain period of time for which there is a need to check the communication.

(e) Collects, by the processing device, data from the email system about the electronic messages communication between that specific employee and that specific customer or supplier in that specific period of time. In this step, the system in which the method is operated collects the relevant information that includes the sent and received emails between that employee and that customer or supplier, during the time period under review.

(f) Analyzes, by the processing device, the collected data. The analysis comprises a step of counting the number of electronic messages that the specific employee sent to that specific customer or supplier during that period of time and counting the number of electronic messages that the specific employee received from that specific customer or supplier during that period of time.

(g) Presents, by the processing device, on the computer a specific management report (13) that includes the amount of the sent and received electronic messages between that specific employee and that specific customer or supplier during that period of time.

The analysis may further comprise a step of identifying subjects of the sent and received electronic messages or a step of identifying one or more summarized common topics of that sent and received electronic messages. In such cases, the specific management report may further include the identified subjects or the identified summarized common topics. The identification of one or more summarized common topics can be executed by the processing device as an automatic computer summarization process.

The goal is to provide the manager with a quick and reliable concise report regarding the scope and nature of the communication between every employee in the organization and every customer or supplier of the organization. The list of email subjects (or a summary of the subjects or topics) provides essential information to the manager. The goal is to enable the utilization and use of existing information (email correspondence in the email system of the organization) to create a new and innovative report that provides the manager with essential information for managing the organization.

The analysis may further comprise a step of identifying one or more involved employees that are identified as CC recipients in the sent and received electronic messages, and in such case, the specific management report may further include details of that identified one or more involved employees.

The method includes three key elements: (a) providing the specific management report that includes the amount of sent and received electronic messages between the specific employee and the specific customer or supplier during the specific period of time; (b) providing the specific management report that includes the identified subjects or the identified summarized common topics of those messages; and (c) providing the specific management report that includes details of the identified one or more involved employees. The present invention refers to a variety of combinations of these three topics, as appears from the claims, and as appears from this disclosure.

Another embodiment of the present invention refers to the method that comprises one or more of the following steps: (a) Connects, by the processing device, to the email system of the organization. (b) Enters, through the computer, the details of the specific employee. (c) Enters, through the computer, details of the specific customer or supplier. (d) Enters, through the computer, the specific period of time. (e) Collects, by the processing device, the data from the email system. (f) Analyzes, by the processing device, the collected data for identifying the subjects or for identifying one or more summarized common topics of the electronic messages. And (g) Presents, by the processing device, on the computer the specific management report that includes the identified subjects or the identified summarized common topics. The analysis may further comprise the step of counting the number of electronic messages and the specific management report may further include the number of that sent and received electronic messages. The analysis may further comprise the step of identifying the one or more involved employees that are identified as CC recipients in those sent and received electronic messages, and the specific management report may further include details of these identified one or more involved employees.

Another embodiment of the present invention refers to the method that comprises one or more of the following steps: (a) (a) Connects, by the processing device, to the email system of the organization. (b) Enters, through the computer, the details of the specific employee. (c) Enters, through the computer, details of the specific customer or supplier. (d) Enters, through the computer, the specific period of time. (e) Collects, by the processing device, the data from the email system. (f) Analyzes, by the processing device, the collected data for identifying the one or more involved employees that are identified as the CC recipients in those sent and received electronic messages. And (g) Presents, by the processing device, on the computer the specific management report that includes the details of the identified one or more involved employees. The analysis may further comprise the step of counting the number of electronic messages and the specific management report may further include the number of that sent and received electronic messages. The analysis may further comprise the step of identifying the subjects or the summarized common topics of those electronic messages, and in such cases, the specific management report may further include these identified subjects or identify summarized common topics. The analysis may further comprise the step of counting the amount of electronic messages, and in such cases, the specific management report may further include these amounts.

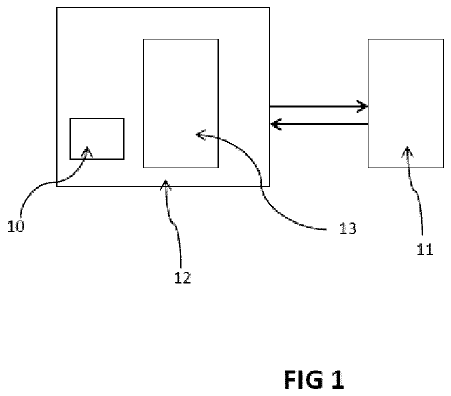

FIG. 1 depicts schematically the processing device (10), the email system (11), the computer (12), and the specific report (13).

What is claimed is:

1. A computer implemented method running on a processing device for producing specific management reports on electronic messages communication between employees of an organization and customers or suppliers of the organization, comprising:
connecting, by the processing device, to an email system in which the electronic messages communication between the employees and the customers or the suppliers is stored,
entering, through a computer, details of a specific employee of the organization,
entering, through the computer, details of a specific customer or supplier of the organization,
entering, through the computer, a specific period of time,
collecting, by the processing device, data from the email system about electronic messages communication between said specific employee and said specific customer or supplier in said specific period of time,
analyzing, by the processing device, said collected data wherein the analysis comprises a step of counting the number of electronic messages that said specific employee sent to said specific customer or supplier during said period of time and counting the number of electronic messages that said specific employee received from said specific customer or supplier during said period of time, and
presenting, by the processing device, on the computer a specific management report that includes the amount of said sent and received electronic messages between said specific employee and said specific customer or supplier during said period of time.

2. The computer implemented method of claim 1, wherein said analysis further comprises a step of identifying subjects of said sent and received electronic messages or a step of identifying one or more summarized common topics of said sent and received electronic messages, and wherein said specific management report further comprises the identified subjects or the identified summarized common topics.

3. The computer implemented method of claim 1, wherein said analysis further comprises a step of identifying one or more involved employees that are identified as CC recipients in said sent and received electronic messages, and wherein said specific management report further includes details of said identified one or more involved employees.

4. A computer implemented method running on a processing device for producing specific management reports on electronic messages communication between employees of an organization and customers or suppliers of the organization, comprising:
connecting, by the processing device, to an email system in which the electronic messages communication between the employees and the customers or the suppliers is stored,
entering, through a computer, details of a specific employee of the organization,
entering, through the computer, details of a specific customer or supplier of the organization,
entering, through the computer, a specific period of time,
collecting, by the processing device, data from the email system about electronic messages communication between said specific employee and said specific customer or supplier in said specific period of time,
analyzing, by the processing device, said collected data wherein the analysis comprises a step of identifying subjects of said sent and received electronic messages or a step of identifying one or more summarized common topics of said sent and received electronic messages, and
presenting, by the processing device, on the computer a specific management report that includes the identified subjects or the identified summarized common topics.

5. The computer implemented method of claim 4, wherein said analysis further comprises a step of counting the number of electronic messages that said specific employee sent to said specific customer or supplier during said period of time and counting the number of electronic messages that said specific employee received from said specific customer or supplier during said period of time, and wherein said specific management report further includes the number of said sent and received electronic messages between said specific employee and said specific customer or supplier during said period of time.

6. The computer implemented method of claim 4, wherein said analysis further comprises a step of identifying one or more involved employees that are identified as CC recipients in said sent and received electronic messages, and wherein said specific management report further includes details of said identified one or more involved employees.

7. A computer implemented method running on a processing device for producing specific management reports on electronic messages communication between employees of an organization and customers or suppliers of the organization, comprising:
connecting, by the processing device, to an email system in which the electronic messages communication between the employees and the customers or the suppliers is stored,
entering, through a computer, details of a specific employee of the organization,
entering, through the computer, details of a specific customer or supplier of the organization,
entering, through the computer, a specific period of time,
collecting, by the processing device, data from the email system about electronic messages communication between said specific employee and said specific customer or supplier in said specific period of time,
analyzing, by the processing device, said collected data wherein the analysis comprises a step of identifying one or more involved employees that are identified as CC recipients in said sent and received electronic messages, and
presenting, by the processing device, on the computer a specific management report that includes details of said identified one or more involved employees.

8. The computer implemented method of claim 7, wherein said analysis further comprises a step of identifying subjects of said sent and received electronic messages or a step of identifying one or more summarized common topics of said sent and received electronic messages, and wherein said specific management report further includes the identified subjects or the identified summarized common topics.

9. The computer implemented method of claim 7, wherein said analysis further comprises a step of counting the number of electronic messages that said specific employee sent to said specific customer or supplier during said period of time and counting the number of electronic messages that said specific employee received from said specific customer or supplier during said period of time, and wherein said specific management report further includes the amount of said sent and received electronic messages between said specific employee and said specific customer or supplier during said period of time.
